(19) United States
(12) Patent Application Publication
(10) Pub. No.: US 2014/0324542 A1
(43) Pub. Date: Oct. 30, 2014

(54) MEDIA FEEDBACK SYSTEM AND METHOD

(71) Applicant: Mobilyzer LLC, Liverpool, NY (US)

(72) Inventors: Todd Marshall, Williamston, MI (US); Karl Selander, Hopewell Junction, NY (US); Mark Weldon, Liverpool, NY (US)

(73) Assignee: Mobilyzer LLC, Liverpool, NY (US)

(21) Appl. No.: 14/260,466

(22) Filed: Apr. 24, 2014

Related U.S. Application Data
(60) Provisional application No. 61/815,560, filed on Apr. 24, 2013.

(51) Int. Cl. G06Q 30/02

(52) U.S. Cl. CPC G06Q 30/0201
USPC 705/7.32; 705/7.29; 705/7.34

(57) ABSTRACT

A mixed voice and data communications means between users having a media deliver means and users having a feedback means intermediated over the communications cloud by a central messaging means that interfaces with common payment processor service, common email service and common video storage service.

### CROSS-REFERENCE TO RELATED APPLICATIONS

The present application claims priority to U.S. Provisional Application No. 61/815,560, filed on Apr. 24, 2013.

### SUMMARY OF THE INVENTION

The present invention comprises a system for soliciting and replaying contextual feedback about media that comprises a server programmed to receive a media module from at least one inquirer and to send the media module to at least one respondent, where the server is also programmed to receive feedback from the respondent and to send the feedback to the inquirer. The system further includes a media delivery device for communicating the media module to the server and a feedback delivery device for communicating the feedback to the server. The respondent may comprise attendees of a particular event and the server can send the media module to a plurality of respondents within a particular geographic area.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a schematic of a system for soliciting, conveying, organizing, storing and replaying contextual feedback according to the present invention.

### DETAILED DESCRIPTION OF THE INVENTION

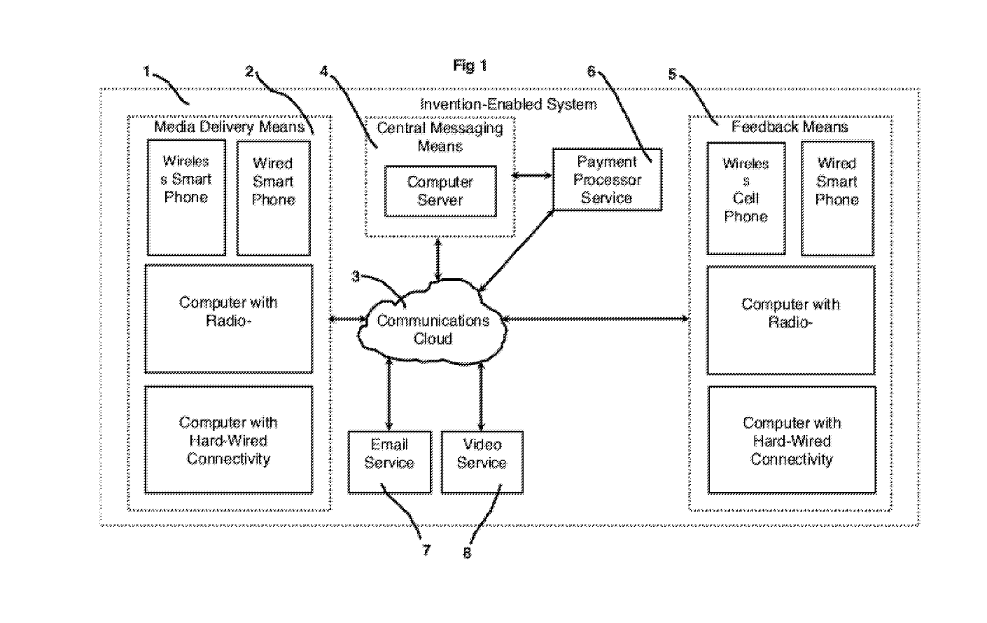

Referring now to the drawings, wherein like reference numerals refer to like parts throughout, there is seen in FIG. 1 a system for soliciting, conveying, organizing, storing and replaying contextual feedback about consumed media in various modes and for handling associated financial transactions as may be desired.

The term “feedback” refers herein to a communicated response from users of the invention that consumed the media, said responses comprising one or more of questions, comments, surveys, polls, ratings, judgments, opinions, estimates, forecasts, sentiments, outlooks, analyses, audits, critiques, inspections, reports, reviews, and associated donations, payments or other financial transactions.

The term “media” refers herein to a corpus comprising one or more of audio, video, graphical, pictorial, textual, numerical or symbolic elements, either pre-recorded and replayed or live and communicated in real-time with concurrent recording. Media may itself expressly elicit point-by-point feedback (herein categorically called a survey) when, for instance, it is in a question and answer format, an opinion poll or some other itemized structure. Or media may have no predetermined insertion points for feedback (herein categorically called a story) and those who provide feedback may elect to insert it at any point in the story relevant to their feedback. Discretionary insertion of feedback into relevant points in a story is highly useful in providing particular context for the feedback. Without the particularity of this identified context, feedback can be ambiguous or tediously explanatory.

The term “mode” refers to the feedback format selected from a group comprising an audio element, video element, graphical element, pictorial element, geospatial element, temporal element, an activated button or symbol, information obtained from scanned bar codes or other indicia or combinations of said elements.

As seen in FIG. 1, the term system (1) refers to a mixed voice and data communications means between users having a media delivery means (2) and users having a feedback means (5) intermediated over the communications cloud (3) by a central messaging means (4) that interfaces with common payment processor service (6), common email service (7) and common video storage service (8).

The media delivery means (2) comprises at least one device selected from a group comprising wireless and wired telephonic devices and wireless and wired computer devices, each embedded with the appropriate software application of the invention. The feedback means (5) comprises at least one device selected from a group comprising wireless and wired telephonic devices, and wireless and wired computer devices, each embedded with the appropriate software application of the invention. Said means (2) and (5) have at least one user interface comprising keystrokes, voice, audio, images, video and text. Said means (2) and (5) preferably have additional capabilities such as are well known, such as the ability to make and store text messages, make and store audio recordings, video recordings, photographs, GPS location, and time stamps.

The communications cloud (3) comprises at least one telephone network, intranet network or internet network, private or public, that enables the central messaging server (4) to inter-exchange media and feedback and which also enables use of common payment processing services (6), common email services (7) and common video storage services (8). Said central messaging means (4) administers portions of the software application of the system (1) that is not stored on the media delivery means (2) or the feedback means (5), intermediating according to pre-specified rules of exchange, providing usage analytics information and processing payments or other financial transactions.

The invention enables a user that wants to post a survey, such user herein known as an inquirer, to transmit digitally via the central messaging means (4), a survey to one or more respondents, whose mode may permit synchronous or asynchronous feedback. In one embodiment, the inquirer transmits surveys or stories solely to pre-identified respondents. In an alternative embodiment, the surveys or stories may be broadcast by means outside the system (1), e.g., in a newspaper or television broadcast, with an invitation for respondents to provide feedback via the system (1).

The invention enables respondents to create one or more items of time-stamped feedback associated with particular moments in a live event (respondents witnessing the event in real-time whether or not in person), said live event being independently time-tracked by the inquirer such that time-stamped feedback directly corresponds with relevant moments in the time-tracked event. Such feedback may be a response to one or more questions posed before the event or posed at times during the event. By way of illustration and without limitation, embodiments include acquiring respondents' feedback regarding particular statements in a speech, feedback regarding particular characters or advertising offers on television and feedback regarding particular moments in cultural or athletic performances. Respondents may transmit said feedback to the inquirer in real-time or use the system (1) to store feedback for later transmission.

The invention also enables respondents to create an item of time-stamped feedback associated with particular moments in a pre-recorded story (e.g., during a video playback), said pre-recorded story having its own run-time-stamping. The feedback time-stamping in such embodiment is the marking of the pre-recorded run-time commencing at a particular video ‘frame’. The inquirer, by know the pre-recorded run-time at the commencement of the feedback can directly associate the feedback and the content of the pre-recording at or around that moment.

The invention also enables an inquirer to send a survey simultaneously to an enormous group of potential respondents without regard to a shared event but at a common time. Said survey could be of the type, “what's the temperature where you are right now?” By associating a time-stamp and the GPS location of the respondents with their feedback, the system enables an inquirer to amass large amounts of time-coordinated and spatially-relevant data.

The invention also enables an inquirer to send a simultaneous survey to all potential respondents who are within a geospatial radius of interest at the moment. Said surveys could, for example, be a useful alert for respondents to spot a missing child in their area. If a respondent of such an survey happened to spot the missing child, the invention allows the respondent to reply to the survey efficiently, capturing the sighting with a tim-stamped and GPS-stamped photo or video, and instantly relaying such feedback to the central messaging means (4) and thereby to the inquirer and/or authorities.

The invention also enables an inquirer to send a simultaneous survey or story to all potential respondents who are in attendance at a particular event or are at a particular place. Examples include, without limitation, sending surveys or stories to trade show attendees or theme park attendees whose identities are not known to the inquirer but who are enrolled respondents having the requisite geospatial presence at that time. Said surveys might be of the type, “will you be attending the keynote address at 3 pm in the main hall?” Or “please rate your experience on our new water safari.” Said stories might be of the type, “please insert your comments in the attached video.”

The invention also enables an inquirer to send to potential respondents of interest a survey that requires those respondents to include photographic or videographic verification, either synchronously or asynchronously, of the respondent's location in order to submit a valid survey response. An example, without limitation, would be a survey that requires a respondent to take a time-stamped photograph of himself in the requisite setting and include such photograph as part of the feedback.

The invention also enables an inquirer to send to potential respondents a survey or story requiring respondents to include photographic or videographic feedback. Examples include, without limitation, “show us the best dog in the dog show?”, “which home near you has the prettiest yard?”, or “show us which street in the city has the worst potholes?”, etc.

The invention also enables an inquirer to send to potential respondents a survey or story soliciting and processing a donation as part of the respondents' feedback. Examples include, without limitation, “if you really like this [cause], please press ‘donate’ and send us your much-needed support”, or a geo-spatially-relevant inquiry might be “if you like this park, please press ‘donate’ and help make this park beautiful again.” Said respondents donations would be relayed by the system (1) for processing by the payment processing service (6) to the account of the inquirer.

The invention also enables an inquirer to send to potential respondents a survey requesting that respondents' feedback include information derived from a barcode or qr cod scanned by a component of the respondents' feedback means (5) along with a photograph taken by a component of the respondents' feedback means (5). An example includes, without limitation, surveys such as “please rate your satisfaction with your recent purchase and include a photo and the information from the product's bar code”.

The invention also enables the feedback to comprise a threaded audio or text conversation to be created at a particular time-stamped moment in recorded media. For example, but without limitation, the media may comprise a video-recorded university lecture subsequently accessed through the communications cloud (3) and students may, through use of their feedback devices (5), place tags on the timeline of the replayed media and said tags become stored as part of the media. Alternatively, the tags may be created and stored temporarily only on the feedback devices (5) for later synchronization and merging with the communications cloud-accessible media, perhaps stored on a common video service (8). Such students may subsequently retrieve the media, locate his or her tag(s) in the media and, through a texting our audio-recording feature of the invention, create and assign a message to the selected tag, e.g., asking a question, making a comment, etc. Such message-carrying tags could then be uploaded by the student and merged with the event recording. All authorized students in the class having the invention would be able to see any tag and its message (unless the originating student assigned a privacy limitation to his or her tag). The publication of the message in this way would enable all students as well as the faculty and teaching assistants to see what other students' questions and comments are at particular points in the delivery of the taught content. Other students could add their comments or questions to the thread of an existing tag as is common in list serves and other threaded conversations known on the web. Or they could create a new tag with a new message if desired. Receiving these tags and messages from the students, the faculty and/or teaching assistant could open the tags, review the messages and add replies to the threads, e.g., answering a raised question. These would be republished as part of the media for other students to read or hear. In this way, a threaded conversation can be inserted at a time-stamped point in the lecture. Seeing the number and placement of student tags in the media and receiving the associated messages would help faculty and/or teaching assistants to see where additional clarity or information may be needed in the lecture. This additional lecture information could be provided in a reply to a tag, if brief, or could be linked by a url provided in a reply, or could assign additional student work in readings, textbooks, etc. This will allow faculty and/or teaching assistants to give timely and convenient assistance with more context than is conveniently provided by emails and with more convenience than is provided by in-person office hours visits. In fact, a faculty and/or teaching assistant could be proactive in assigning their own tags to the media with messages that contain additional information that could not be covered in the time constraints of the lecture. This allows contextual secondary materials to be placed in the flow of the lecture much like verbal parenthetical statements or printed textbook footnotes. The media, after the completion of the tagging, messaging, threading and amplification processes are sufficiently complete, may be edited by faculty and/or teaching assistants and archived for re-use in future in-person or distance-ed classes. In this way, a body of knowledge and enriched interaction may be created over time.

Because the feedback that respondents provide to surveys or stories may in some cases be financially valuable to inquirers, the invention enables willing inquirers to compensate willing respondents for their feedback using the payment processing service (6) to provide respondents with micro-payments or larger sums. Such compensation may be a flat amount for all items of feedback or may assign different values to different items of feedback according to inquirer's parameters. These parameters are administered by the central messaging means (4) interacting with the payment processing service (6).

What is claimed is:

1. A system for soliciting and replaying contextual feedback about media, comprising:
a server programmed to receive a media module from at least one inquirer and to send said media module to at least one respondent;
said server being further programmed to receive feedback from said respondent and to send said feedback to said inquirer.

2. The system of claim 1 further comprising:
a media delivery device for communicating said media module to said server; and
a feedback delivery device for communicating said feedback to said server.

3. The system of claim 1, wherein said respondent is pre-determined.

4. The system of claim 1, wherein said respondent comprises attendees of a particular event.

5. The system of claim 1, wherein said server sends said media module to a plurality of respondents within a particular geographic area.

6. The system of claim 1, wherein said media module is a prompt.

7. The system of claim 6, wherein said prompt is a survey.

8. The system of claim 1, wherein said media module is a video.

9. The system of claim 8, wherein said video is a live stream.

10. The system of claim 1, wherein said feedback is a picture.

11. The system of claim 1, wherein said feedback is a video.

12. The system of claim 1, wherein said feedback is stamped with data representing the time said respondent sent said feedback.

13. The system of claim 1, wherein said feedback is stamped with data representing a geo-location of said respondent at the time said respondent receiver sent said feedback.

14. The system of claim 11, wherein said video contains run-time-stamping data and said feedback is associated with a particular run-time-stamp in said video.

15. The system of claim 1, wherein said media module solicits payments.

16. The system of claim 15, further comprising a payment processing module for receiving payments from respondents in response to said media module soliciting payments.

17. The system of claim 1, wherein said feedback is threaded to allow multiple respondents to reply to feedback sent from other respondents.
